(19) United States
(12) Patent Application Publication
(10) Pub. No.: US 2021/0182009 A1
(43) Pub. Date: Jun. 17, 2021

(54) DISPLAY DEVICE, DISPLAY SYSTEM, AND DISPLAY METHOD

(71) Applicant: SHARP KABUSHIKI KAISHA, Osaka (JP)

(72) Inventor: AKIYOSHI OHYA, Osaka (JP)

(21) Appl. No.: 17/115,015

(22) Filed: Dec. 8, 2020

(30) Foreign Application Priority Data
Dec. 13, 2019 (JP) 2019-225538

(51) Int. Cl. G06F 3/14; G06F 3/0488; G09G 5/38; G09G 5/14; G09G 5/373

(52) U.S. Cl. CPC G06F 3/1423; G06F 3/0488; G09G 5/38; G09G 2380/08; G09G 5/373; G09G 2340/045; G09G 2354/00; G09G 5/14

(57) ABSTRACT

A display system includes a first display device and a second display device. The first display device includes a first display and a first operator. The second display device includes a second display. When one part of the display image displayed on the first display is designated by a touch operation, the second display displays an extracted image. The extracted image is an image obtained by extracting, from the display image, a partial image including a portion designated by the touch operation in the display image.

### BACKGROUND OF THE INVENTION

### Field of the Invention

The present invention relates to a display device, a display system, and a display method.

### Description of the Background Art

Japanese Patent Laid-Open No. 2018-182511 discloses a technology that in a case where a user performs enlargement operation to a first display device among the first display device and a second display device, when the second display device is set so as to display the same image as the first display device, a trimming image of a display image is displayed on the first display device, and when the second display device is not set so as to display the same image as the first display device, an enlarged image of the display image is displayed on the first display device.

When the first display device and the second display device are daisy chain-connected, it is possible to extract one part of the display image displayed on the first display device and display an extracted image on the second display device.

However, a user needs to set enlargement (set the magnification of the extracted image and set a display place of the extracted image) for each display device, which is complicated.

An object of the present invention is to provide a display device, a display system, and a display method with which a user is capable of easily displaying an extracted image.

### SUMMARY OF THE INVENTION

According to a first aspect of the present application, a display system includes a first display device and a second display device. The second display device is communicably connected to the first display device. The first display device includes a first display and an operator. The first display displays an image. The operator accepts a touch operation to the first display. The second display device includes a second display that displays an image. When one part of a display image displayed on the first display is designated by the touch operation, the second display displays an extracted image. The extracted image is an image obtained by extracting, from the display image, a partial image including a portion designated by the touch operation in the display image.

According to a second aspect of the present application, a display device is communicably connected to a display device including a first display. The display device includes a second display that displays an image. When one part of the display image displayed on the first display is designated by a touch operation to the first display, the second display displays an extracted image. The extracted image is an image obtained by extracting, from the display image, a partial image including a portion designated by the touch operation in the display image.

According to a third aspect of the present application, a display method uses a first display device and a second display device communicably connected to the first display device. The display method includes displaying a display image on a first display included in the first display device. The display method includes designating one part of the display image by a touch operation to the first display. The display method includes displaying an extracted image on a second display included in the second display device. The extracted image is an image obtained by extracting, from the display image, a partial image including a portion designated by the touch operation in the display image.

According to the present invention, a user can easily display an extracted image.

### BRIEF DESCRIPTION OF THE DRAWINGS

FIG. 1 is a schematic diagram illustrating a display system according to an embodiment of the present invention;

FIG. 2 is a block diagram illustrating a configuration of a first display device;

FIG. 3 is a block diagram illustrating a configuration of a second display device;

FIG. 4 is a flow chart illustrating the operation of a display system;

FIG. 5 is a diagram illustrating the states of the first display device and the second display device at the start of the operation of the display system;

FIG. 6 is a diagram illustrating a state in which one part of a display image displayed on the first display is designated by a touch operation;

FIG. 7 is a diagram illustrating a partial image;

FIG. 8A to FIG. 8C are schematic diagrams each illustrating a state in which a creator of the second display device creates an extracted image;

FIG. 9 is a diagram illustrating a state in which the extracted image is displayed on the second display;

FIG. 10 is a diagram illustrating a first example of a multiple display process;

FIG. 11 is a diagram illustrating a second example of a multiple display process; and

FIG. 12 is a flow chart illustrating the operation of the first display device that performs the multiple display process.

### DESCRIPTION OF THE PREFERRED EMBODIMENTS

Hereinafter, an embodiment of the present disclosure will be described with reference to the drawings. In the drawings, the same or corresponding portions are denoted by the same reference numerals, and will not be repeatedly described.

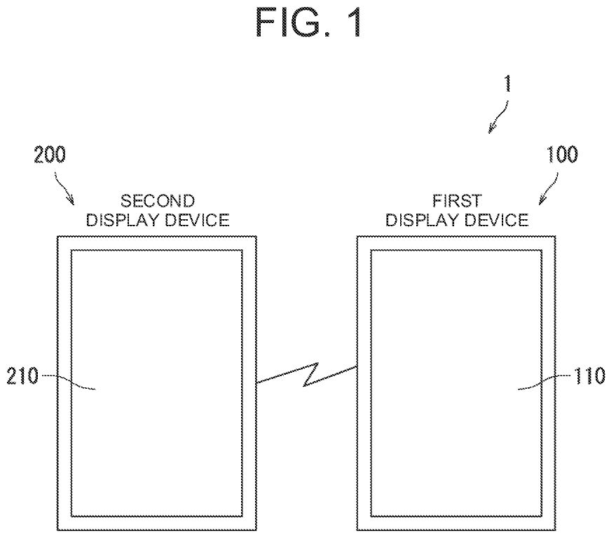

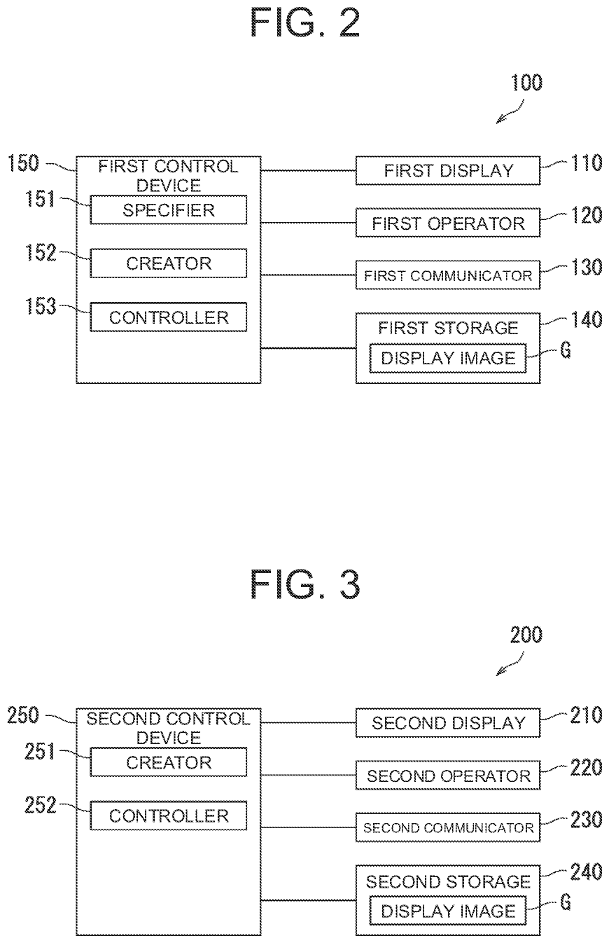

A display system 1 according to the embodiment of the present invention will be described with reference to FIG. 1 to FIG. 2. FIG. 1 is a schematic diagram illustrating the display system 1 according to the embodiment of the present invention.

As illustrated in FIG. 1, the display system 1 displays an image on a plurality of display devices. The display devices are each, for example, a liquid crystal display, an EL (Electro-Luminescence) display, or a plasma display (PDP).

The display system 1 includes a first display device 100 and a second display device 200.

The first display device 100 and the second display device 200 are connected to each other by using a serial cable so as to enable mutual cable communication. The first display device 100 and the second display device 200 are, for example, daisy chain-connected. The first display device 100 and the second display device 200 may be connected to each other so as to enable wireless communication, for example, by Bluetooth (registered trademark) or Wifi.

FIG. 2 is a block diagram illustrating a configuration of the first display device 100.

As illustrated in FIG. 2, the first display device 100 includes a first display 110, a first operator 120, a first communicator 130, a first storage 140, and a first control device 150.

The first display 110 includes a panel that displays an image, such as a liquid crystal panel.

The first operator 120 accepts an instruction to the first display device 100. The first operator 120 includes, for example, a resistive film type, a capacitance type, or an optical type touch panel, and accepts a touch operation to the first display 110. The first operator 120 includes a receiver that receives an infrared code output from an operation key provided in a housing of the first display device 100 and/or a remote controller of the first display device 100.

The first communicator 130 communicates with the second display device 200. The first communicator 130 includes a communication module (communication device), such as a connection port for connecting a serial cable or a wireless LAN board.

The first storage 140 includes a main storage device (for example, a semiconductor memory) such as a ROM (Read Only Memory) and a RAM (Random Access Memory), and may further include an auxiliary storage device (for example, a hard disk drive). The first storage 140 stores various computer programs executed by the first control device 150. The first storage 140 stores image data of a display image G. The display image G will be later described. Further, the first storage 140 stores information about the second display device 200 (for example, information about the resolution of the second display 210 of the second display device 200). In the first embodiment, the resolution of the first display 110 is the same as that of the second display 210. The resolution of the first display 110 may be different from that of the second display 210.

The first control device 150 includes a processor such as a CPU (Central Processing Unit) and an MPU (Micro Processing Unit). The first control device 150 controls each element of the first display device 100 by executing the computer programs stored in the first storage 140.

The first control device 150 has a specifier 151, a creator 152, and a controller 153. Specifically, the processor of the first control device 150 functions as the specifier 151, the creator 152, and the controller 153 by executing a computer program stored in the first storage 140.

FIG. 3 is a block diagram illustrating a configuration of the second display device 200.

As illustrated in FIG. 3, the second display device 200 includes a second display 210, a second operator 220, a second communicator 230, a second storage 240, and a second control device 250.

The second display 210, the second operator 220, the second communicator 230, the second storage 240, and the second control device 250 of the second display device 200 have the same configurations as the first display 110, the first operator 120, the first communicator 130, the first storage 140, and the first control device 150 of the first display device 100 (see FIG. 2), respectively, and therefore detailed description will be omitted.

The second storage 240 stores various computer programs executed by the second control device 250. The second storage 240 stores the image data of the display image G.

The second control device 250 controls each element of the second display device 200 by executing the computer program stored in the second storage 240. The second control device 250 has a creator 251 and a controller 252. Specifically, a processor of the second control device 250 functions as the creator 251 and the controller 252 by executing computer programs stored in the second storage 240.

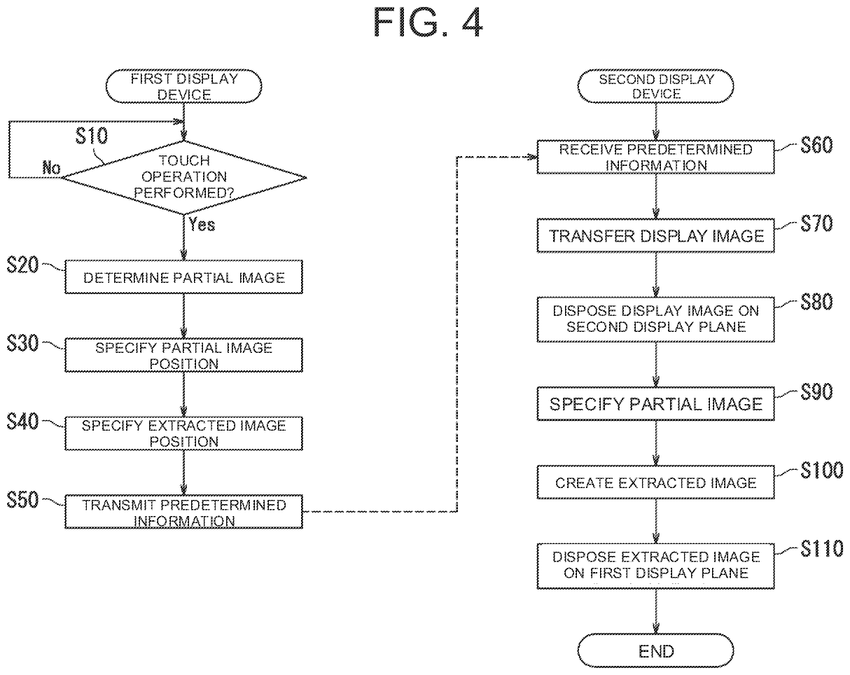

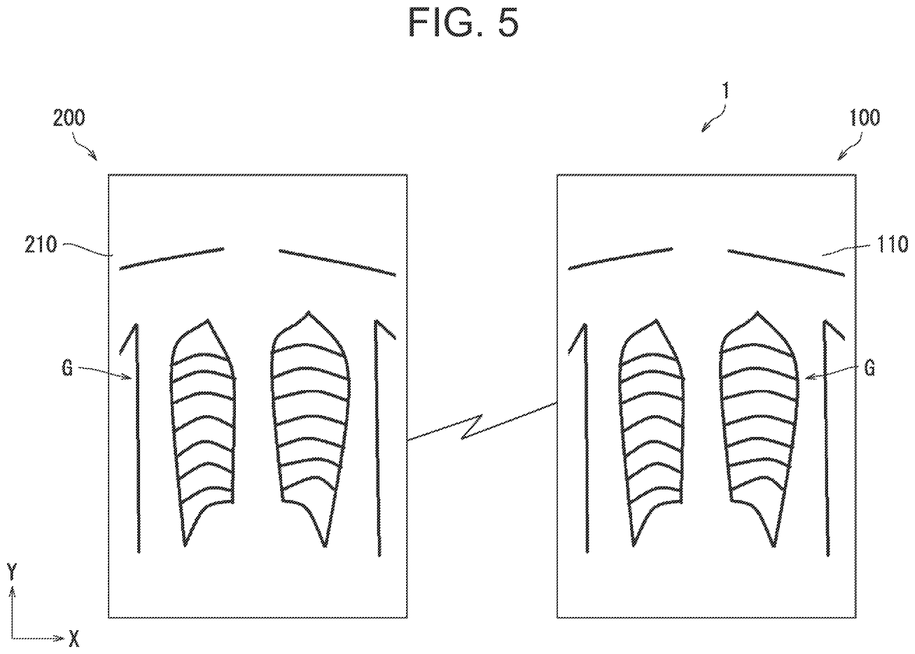

The operation of the display system 1 will be described with reference to FIG. 2 to FIG. 9. FIG. 4 is a flow chart illustrating the operation of the display system 1. FIG. 5 is a diagram illustrating the states of the first display device 100 and the second display device 200 at the start of the operation of the display system 1.

First, the states of the first display device 100 and the second display device 200 at the start of the operation of the display system 1 will be first described with reference to FIG. 5.

As illustrated in FIG. 5, in this embodiment, the display system 1 is used in a medical field. Each of the first display device 100 and the second display device 200 is, for example, a medical display device. The first display 110 of the first display device 100 and the second display 210 of the second display device 200 are arranged side by side. The display image G is displayed on each of the first display 110 and the second display 210. In this embodiment, the display image G is an X-ray image. The display image G may be an image other than the X-ray image, and the type of the display image G is not particularly limited.

Now, the operation of the first display device 100 among the operations of the display system 1 will be described with reference to FIG. 2 and FIG. 4 to FIG. 7.

As illustrated in FIG. 2, FIG. 4, and FIG. 5, in step S10, the controller 153 of the first display device 100 determines whether or not one part of the display image G displayed on the first display 110 is designated by a touch operation in a state in which the display image G is displayed on each of the first display 110 and the second display 210.

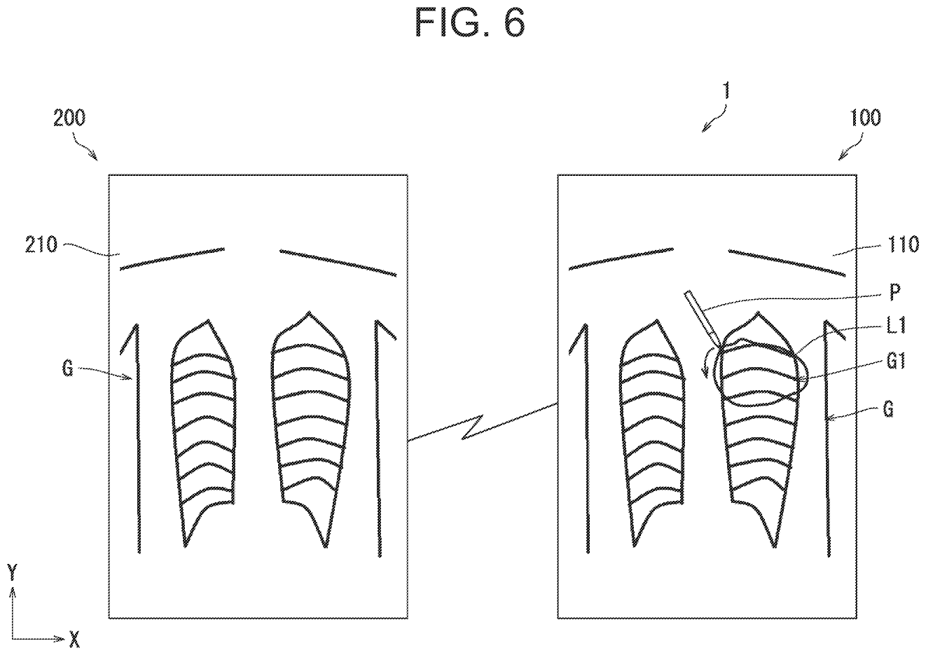

FIG. 6 is a diagram illustrating a state in which the one part of the display image G displayed on the first display 110 is designated by the touch operation.

As illustrated in FIG. 6, the one part of the display image G displayed on the first display 110 is designated by, for example, the touch operation by a touch pen P. In this case, a user slides the touch pen P on the first display 110, and surrounds a desired portion of the display image G. As a result, the portion of the display image G, which is surrounded by the sliding operation of the touch pen P, becomes a portion designated by the touch operation. The touch operation may be performed with a finger.

When the touch operation to the first display 110 is performed, the controller 153 displays an annular line image L1 illustrating the trajectory of the touch operation on the display image G displayed on the first display 110. In other words, the trajectory of the touch operation is the trajectory of the movement of the touch pen P. The line image L1 is displayed on, for example, an OSD (On Screen Display).

In this embodiment, a designated portion G1 surrounded by the line image L1 in the display image G is designated by the touch operation. The touch operation is not limited to the slide operation surrounding a desired portion of the display image G. The touch operation only needs to be operation in which an object such as a touch pen or a finger touches the display image G displayed on the first display 110. The touch operation may be, for example, a tap operation. In this case, when the tap operation (long press operation) is performed on the display image G, a portion located within a predetermined range centered on a tapped location in the display image G becomes a portion designated by the touch operation. The predetermined range is determined, for example, according to the size of the display image G, or according to the resolution of the first display 110.

By displaying the line image L1 on the first display 110, the user can visually recognize the designated portion G1 designated by himself/herself in the display image G.

As illustrated in FIG. 2, FIG. 4, and FIG. 6, when the controller 153 determines that one part of the display image G is designated by the touch operation (Yes in step S10), the process shifts to step S20. On the other hand, when the controller 153 determines that one part of the display image G is not designated by the touch operation (No in step S10), the process illustrated in step S10 is repeated.

In step S20, the controller 153 determines a partial image G11.

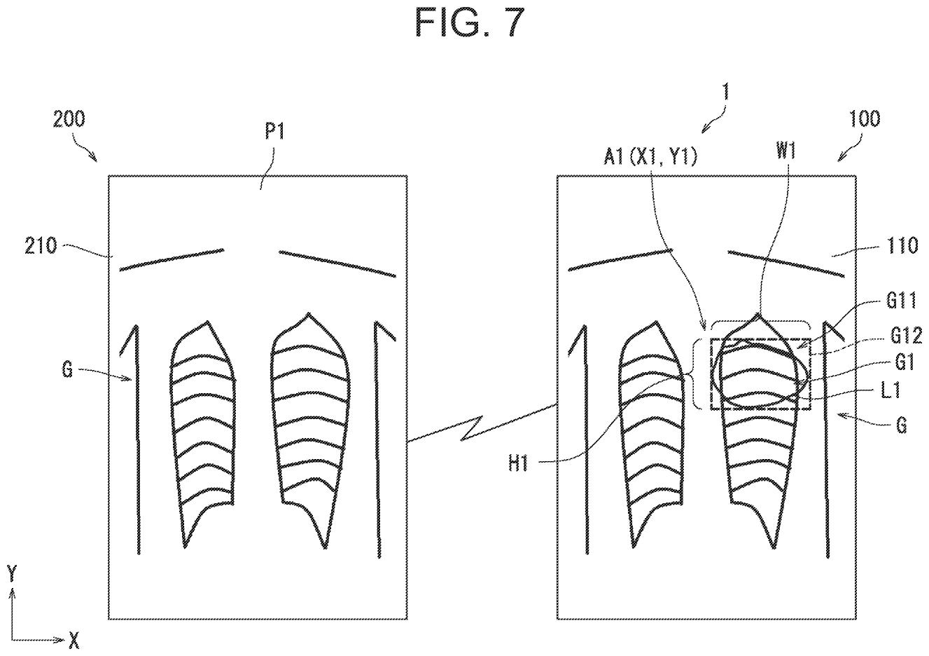

FIG. 7 is a diagram illustrating the partial image G11.

As illustrated in FIG. 7, the partial image G11 is an image including the designated portion G1 designated by the touch operation in step S10.

A frame part G12 of the partial image G11 is formed in a rectangular shape (circumscribed rectangle) composed of two sides parallel to an X-axis and two sides parallel to a Y-axis. The frame part G12 of the partial image G11 circumscribes the designated portion G1 (line image L1). The X-axis and the Y-axis are axes perpendicular to each other.

In FIG. 7, the frame part G12 of the partial image G11 is displayed on the display image G displayed on the first display 110 for convenience of explanation, but an image representing the frame part G12 is not actually displayed on the display image G. The image representing the frame part G12 may be displayed on the display image G.

As illustrated in FIG. 2, FIG. 4, and FIG. 7, in step S30, the specifier 151 specifies a partial image position. The partial image position indicates an area where the partial image G11 is located on the first display 110. The partial image position is composed of the coordinates (X1, Y1) of the apex A1 of the partial image G11, the dimension (number of pixels) H1 in the Y-axis direction of the partial image G11, and the dimension (number of pixels) W1 in the X-axis direction of the partial image G11.

In this embodiment, the frame part G12 of the partial image G11 is formed in a rectangular shape while circumscribing the line image L1. As a result, the specifier 151 can easily specify the partial image position on the basis of the coordinates of the line image L1.

In step S40, the specifier 151 specifies the extracted image position.

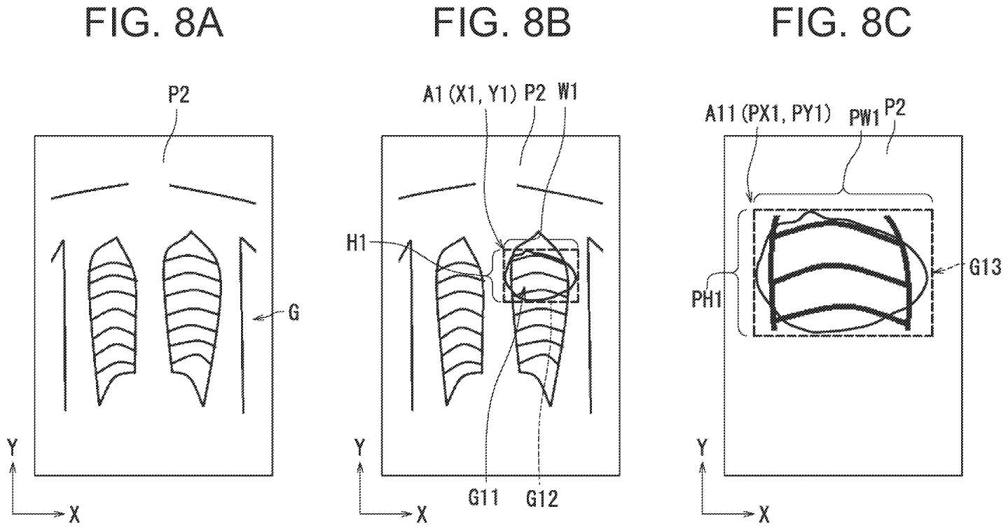

The extracted image position indicates an area where an extracted image G13 (see FIG. 8C) is located on the second display 210.

The extracted image G13 is an image corresponding to the partial. image G11 extracted from the display image G displayed on the first display 110, and has a size which is the same as or similar to the size of the partial image G11. In this embodiment, the extracted image G13 is a similarly enlarged image of the partial image G11.

The extracted image position is composed of the coordinates (PX1, PY1) of the apex A11 of the extracted image G13, the dimension (number of pixels) PH1 in the Y-axis direction of the extracted image G13, and the dimension (number of pixels) PW1 in the X-axis direction of the extracted image G13 (See FIG. 8C). The coordinates (PX1, PY1) are values that define the position of the extracted image G13. The dimension PH1 and the dimension PW1 are values that define the size of the extracted image G13.

The extracted image G13 is generated by enlarging the dimension of the partial image G11 from the dimensions H1 and W1 to the dimensions PH1 and PW1 (in other words, by enlarging the partial image G11 at the same magnification). The size of the extracted image G13 is determined on the basis of the size of the partial image G11 and the resolution of the second display 210.

The values (dimension PH1 and dimension PW1) that define the size of the extracted image G13 are set to, for example, such values that the extracted image G13 is larger than the partial image G11 and the entire extracted image G13 fits in the second display 210. An upper limit of the values that define the size of the extracted image G13 may be set in order to prevent the extracted image G13 from becoming coarse. In addition, a lower limit of the values that define the size of the extracted image G13 may be further set in order to prevent the crush of the extracted image G13.

The values (coordinates (PX1, PY1)) that define the position of the extracted image G13 are, for example, such values that the extracted image G13 is disposed with the central part in the image display area of the second display 210 as the center.

In step S50, the controller 153 controls the first communicator 130 such that the first communicator 130 transmits predetermined information to the second display device 200.

The predetermined information includes information indicating a display request instruction, information indicating the partial image position specified in step S30 (the coordinates (X1, Y1), the dimensions H1, and the dimensions W1), and information indicating the extracted image position specified in step S40 (the coordinates (PY1, PY1), the dimension PH1, and the dimension PW1).

The display request instruction is a control command instructing the second display device 200 to display the extracted image G13. The information indicating the partial image position is an example of partial image position information of the present invention. The information indicating the extracted image position is an example of extracted image position information of the present invention.

When the process illustrated in step S50 is completed, the process of the first display device 100 is completed.

In step S60, the second communicator 230 of the second display device 200 receives the predetermined information. When the process illustrated in step S60 is completed, the process shifts to step S70.

Next, the operation of the second display device 200 among the operation of the display system 1 will be described with reference to FIG. 3 to FIG. 9.

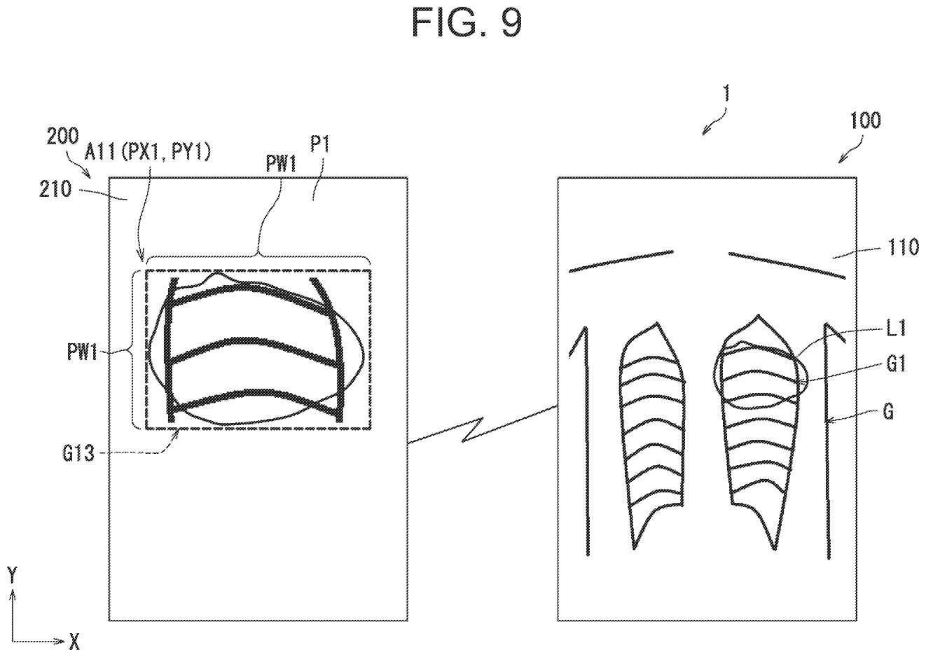

FIG. 8A to FIG. 8C are schematic views each illustrating a state in which the creator 251 of the second display device 200 creates the extracted image G13. FIG. 9 is a diagram illustrating a state in which the extracted image G13 is displayed on the second display 210.

The second display device 200 receives the display request instruction included in the predetermined information in step S60 (see FIG. 4), so that a process of displaying the extracted image G13 (FIG. 8C) on the second display 210 is started in step S70 and subsequent steps.

As illustrated in FIG. 3, FIG. 4, and FIG. 7, in step S70, the creator 251 of the second display device 200 transmits, into a buffer of the second storage 240, image data of the display image G disposed on a first display plane P1 on the second display 210.

As illustrated in FIG. 3, FIG. 4, and FIG. 8A, in step S80, the creator 251 sets a second display plane P2 having the same resolution as the first display plane P1 in the buffer, and disposes the display image G on the second display plane P2.

As illustrated in FIG. 3, FIG. 4, and FIG. 8B, in step 890, the creator 251 specifies a portion where the partial image G11 of the display image G on the second display plane P2 is located, on the basis of the predetermined information (information indicating the partial image position) acquired in step S60.

As illustrated in FIG. 3, FIG. 4, and FIG. 8C, in step S100, the creator 251 creates the extracted image G13 on the second display plane P2 by enlarging the partial image G11 and determining the position on the second display plane P2 on the basis of the predetermined information (information indicating the extracted image position) acquired in step S60.

As illustrated in FIG. 3, FIG. 4, and FIG. 9, in step S110, the controller 252 erases the display image G disposed on the first display plane P1, and disposes, on the first display plane P1, the extracted image G13 (see FIG. 8C) created on the second display plane P2 in step S100. The first display plane P1 is located in the image display area of the second display 210. As a result, the extracted image G13 is displayed on the second display 210 instead of the display image G.

When the process illustrated in step S110 is completed, the process is completed.

As described above with reference to FIG. 2 to FIG. 9, when the one part of the display image G displayed on the first display 110 is designated by the touch operation, the second display 210 displays the extracted image G13. Therefore, the user can display the extracted image G13 on the second display 210 by the touch operation to the first display 110, and does not need to perform enlargement setting for each display device. As a result, the user can easily display the extracted image G13 on the second display 210.

The embodiment of the present invention is thus described with reference to the drawings (FIG. 1 to FIG. 9). However, the present invention is not limited to the above embodiment, and can be implemented in various embodiments without departing from the gist thereof (for example, (1) to (2)). In addition, various inventions can be formed by appropriately combining a plurality of components disclosed in the above embodiment. For example, some components may be deleted from all the components described in the embodiment. In order to facilitate understanding, the drawings schematically illustrate each component as a main body, and the number and the like of each of the components illustrated in the drawings may differ from actual ones for the convenience of drawing creation. Further, each component described in the above embodiment is an example and is not particularly limited, and various changes can be made without substantially deviating from the effects of the present invention.

(1) In this embodiment, the creator 251 of the second display device 200 creates the extracted image G13. However, the present invention is not limited to this. The creator 152 of the first display device 100 may create the extracted image G13. In this case, for example, the first display device 100 and the second display device 200 are non daisy chain-connected.

In this case, the creator 152 of the first display device 100 creates the extracted image G13 by performing the processes illustrated in FIG. 8A to FIG. 8C in the buffer of the first storage 140. Then, in step S50 (see FIG. 4), instead of the information indicating the partial image position and the information indicating the extracted image position, information indicating the extracted image G13 created by the creator 152 of the first display device 100 is transmitted from the first display device 100 to the second display device 200. As a result, the controller 252 of the second display device 200 erases the display image G from the second display 210 and displays the extracted image G13 on the second display 210. As a result, the second control device 250 of the second display device 200 does not need to create the extracted image G13, so that the arithmetic load of the second control device 250 can be reduced.

(2) In a case where a plurality of touch operations are performed on the first display 110, the controller 252 may perform a multiple display process of displaying a plurality of extracted images on the second display 210.

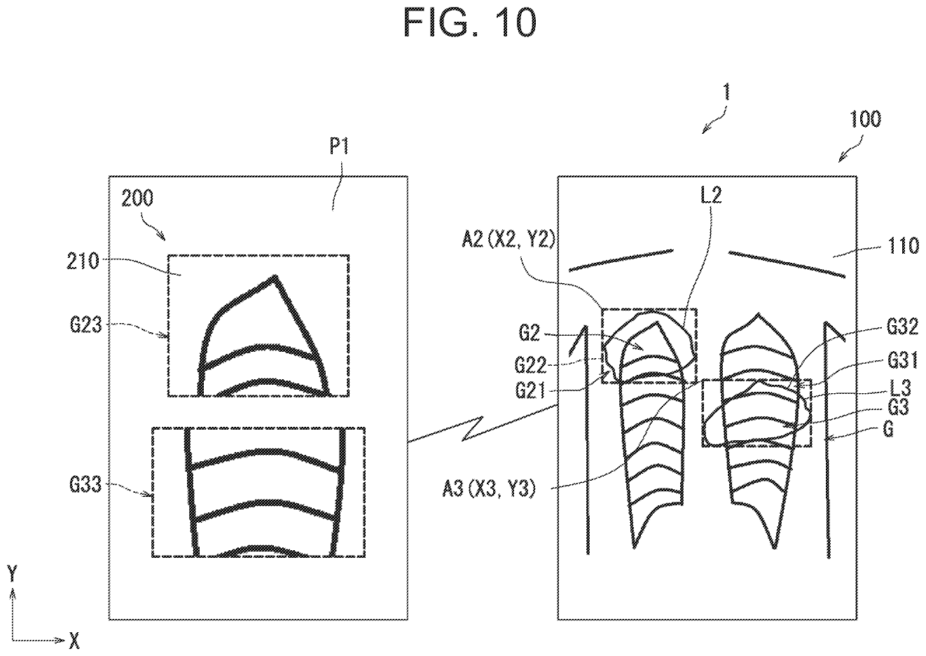

In the following, a first example of the multiple display process will be described with reference to FIG. 2 and FIG. 10.

FIG. 10 is a diagram illustrating the first example of the multiple display process.

As illustrated in FIG. 2 and FIG. 10, a plurality of touch operations performed on the first display 110 include a touch operation performed along a line image L2 and a touch operation performed along a line image L3.

When the touch operation along the line image L2 is performed on the first display 110, a partial image G21 is determined on the basis of the line image L2. The partial image G21 is an image located in a rectangular frame part G22 surrounding the line image L2 in the display image G. The frame part G22 may be displayed or may not be displayed on the display image G. Then, the partial image G21 is extracted from the display image G, so that an extracted image G23 is created. Then, the extracted image G23 is displayed on the second display 210.

When the touch operation along the line image L3 is performed on the first display 110, a partial image G31 is determined on the basis of the line image L3. The partial image G31 is an image located in a rectangular frame part G32 surrounding the line image L3 in the display image G. The frame part G32 may be displayed or may not be displayed on the display image G. Then, the partial image G31 is extracted from the display image G, so that the extracted image G33 is created. Then, the extracted image G33 is displayed on the second display 210.

The position of the partial image G21 and the position of the partial image G31 are different from each other at the position in the Y-axis direction on the first display 110. In this case, the extracted image G23 and the extracted image G33 are displayed on the second display 210 side by side along the Y-axis direction in a state in which such size that the extracted image G23 and the extracted image G33 fit within the second display 210 is ensured. For example, the position of the partial image G21 indicates the coordinates (X2, Y2) of the apex A2 of the partial image G21, and the position of the partial image G31 indicates the coordinates (X3, Y3) of the apex A3 of the partial image G31.

On the first display 110, the partial image G21 and the partial image G31 are arranged along the Y-axis direction in the order of the partial image G31 and the partial image G21. In accordance with the above, on the second display 210, the extracted image G23 and the extracted image G33 are arranged along the Y-axis direction in the order of the extracted image G33 and the extracted image G23.

When the line image L3 is erased on the first display 110, the extracted image G33 is erased on the second display 210, and the display position of the extracted image G23 is changed to the central part of the second display 210. When the line image L2 is erased on the first display 110, the extracted image G23 is erased on the second display 210, and the display position of the extracted image G33 is changed to the central part of the second display 210. As a result, in a case where the extracted image that is one of the extracted image G23 and the extracted image G33 is no longer needed, a user can leave only a necessary extracted image on the second display 210.

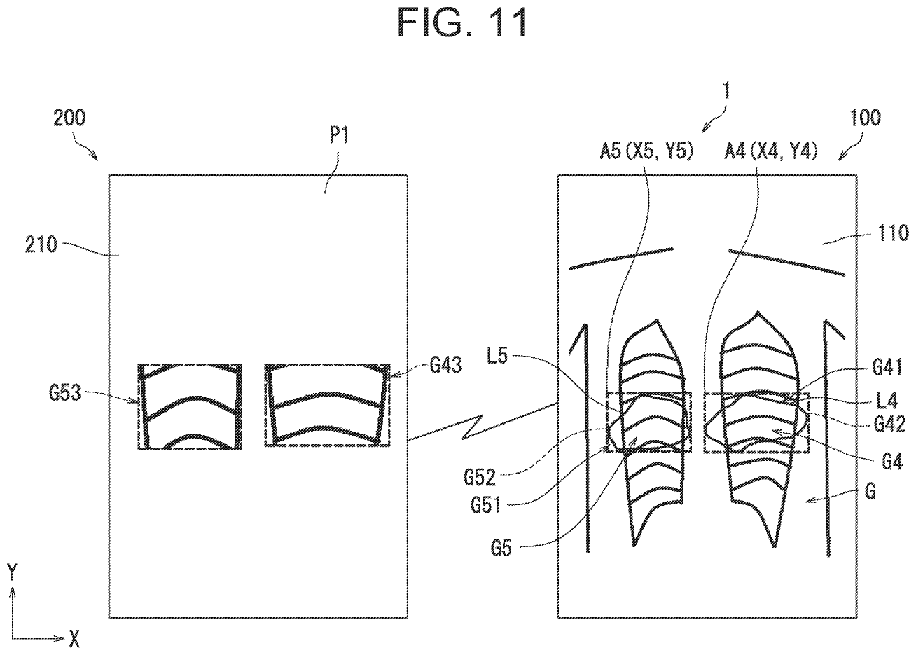

In the following, a second example of the multiple display process will be described with reference to FIG. 2 and FIG. 11.

FIG. 11 is a diagram illustrating the second example of the multiple display process.

As illustrated in FIG. 2 and FIG. 11, a plurality of touch operations performed on the first display 110 include a touch operation performed along a line image L4 and a touch operation performed along a line image L5.

When a touch operation along the line image L4 is performed on the first display 110, a partial image G41 is determined on the basis of the line image L4. The partial image G41 is an image located in a rectangular frame part G42 surrounding the line image L4 in the display image G. The frame part G42 may be displayed or may not be displayed on the display image G. Then, the partial image G41 is extracted from the display image G, so that the extracted image G43 is created. Then, the extracted image G43 is displayed on the second display 210.

When a touched operation along a line image L5 is performed on the first display 110, a partial image G51 is determined on the basis of the line image L5. The partial image G51 is an image located in a rectangular frame part G52 surrounding the line image L5 in the display image G. The frame part G52 may be displayed or may not be displayed on the display image G. Then, the partial image G51 is extracted from the display image G, so that the extracted image G53 is created. Then, the extracted image G53 is displayed on the second display 210.

The position of the partial image G41 and the position of the partial image G41 are the same at the position in the Y-axis direction on the first display 110, In this case, the extracted image G43 and the extracted image G53 are displayed on the second display 210 side by side along the X-axis direction in a state in which such size that the extracted image G43 and the extracted image G53 fit within the second display 210 is ensured.

For example, the position of the partial image G41 indicates the coordinates (X4, Y4) of the apex A4 of the partial image G41, and the position of the partial image G51 indicates the coordinates (X5, Y5) of the apex A5 of the partial image G51.

The case where the position of the partial image G41 and the position of the partial image G41 are the same at the position in the Y-axis direction on the first display 110 includes not only a case where the Y coordinate Y4 of the apex A4 of the partial image G41 and the Y coordinate Y5 of the apex A5 of the partial image G51 are exactly the same, but also a case where the Y coordinate 14 of the apex A4 of the partial image G41 and the Y coordinate Y5 of the apex A5 of the partial image G51 are slightly different (for example, a few pixels are different).

The partial image G41 and the partial image G51 are arranged on the first display 110 side by side along the X-axis direction in the order of the partial image G51 and the partial image G41. In accordance with the above, the extracted image G43 and the extracted image G53 are arranged on the second display 210 side by side along the X-axis direction in the order of the extracted image G53 and the extracted image G43.

When the line image L5 is erased on the first display 110, the extracted image G53 is erased on the second display 210, and the display position of the extracted image G43 is changed to the central part of the second display 210. When the line image L4 is erased on the first display 110, the extracted image G43 is erased on the second display 210 and the display position of the extracted image G53 is changed to the central part of the second display 210.

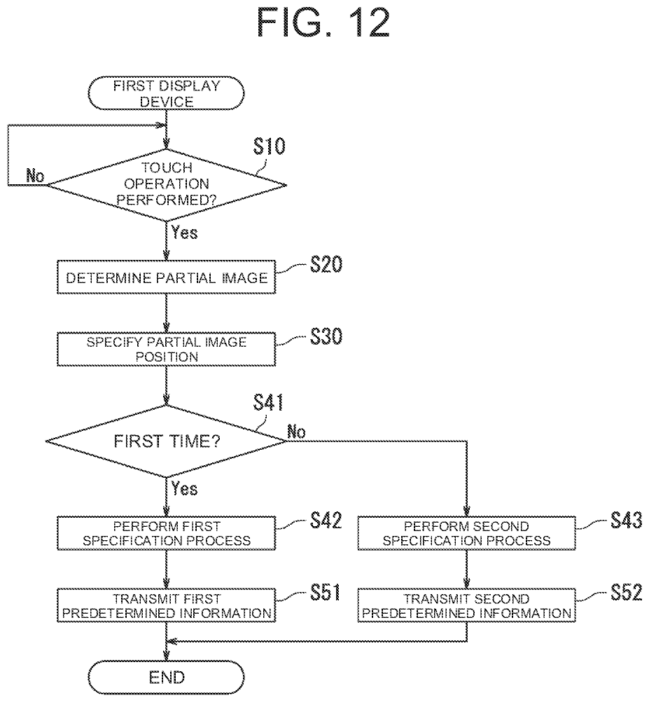

Now, the operation of the first display device 100 when the multiple display process is performed will be described with reference to FIG. 4 and FIG. 10 to FIG. 12. FIG. 12 is a flow chart illustrating the operation of the first, display device 100 that performs the multiple display process. Processes illustrated in step S10 to step S52 of FIG. 12 are a modification of the processes (step S10 to step S50) performed by the first display device 100 among the processes illustrated in step S10 to step S110 of FIG. 4.

As illustrated in FIG. 12, when the processes illustrated in step S10 to step S30 are performed, the process shifts to step S41.

In step S41, the controller 153 of the first display device 100 determines whether a first touch operation is performed or a second touch operation is performed, in step S10.

In a case where the controller 153 determines that the first touch operation is performed (Yes in step S41), the process shifts to step S42.

In this embodiment, in a case where the first touch operation is performed, the partial image G11 (see FIG. 7) is determined in step S20, and the partial image position of the partial image G11 is specified in step S30.

In a case where the controller 153 determines that the second touch operation is performed (No in step S41), the process shifts to step S43.

In this embodiment, in a case where the second touch operation is performed, the partial image G21 is determined by the first touch operation of the two touch operations and the partial image G31 is determined by the second touch operation (see FIG. 10) in step S20. Then, in step S30, the partial image position of the partial image G21 and the partial image position of the partial image G31 are specified.

In step S42, the specifier 151 performs a first specification process. The first specification process is a process of specifying the extracted image position of the extracted image G13 which is an enlarged image of the partial image G11. In this case, the specifier 151 specifies the extracted image position such that the extracted image G13 is disposed in the central part of the image display area of the second display 210.

In step S51, first predetermined information is transmitted from the first display device 100 to the second display device 200. The first predetermined information includes information indicating a first display request instruction, information indicating the partial image position of the image G11 specified in step S30, and information indicating the extracted image position of the extracted image G13 specified in step S42. The first display request instruction is a control command instructing the second display device 200 to display the extracted image G13 at the extracted image position.

Then, the second display device 200 receives the first predetermined information and performs the processes illustrated in step S60 to step S110 in FIG. 4. As a result, the extracted image G13 is displayed on the second display 210 (see FIG. 9).

In step S43, the specifier 151 performs a second specification process. The second specification process is a process of specifying the extracted image position of the extracted image G23 which is an enlarged image of the partial image G21, and the extraction image position of the extracted image G33 which is an enlarged image of the partial image G31. In this case, the specifier 151 divides the image display area of the second display 210 into a first area located on one side (upper side) in the Y-axis direction and a second area located on the other side (lower side), specifies the extracted image position of the extracted image G23 such that, the extracted image G23 is disposed with the central part of the first area as the center, and specifies the extracted position of the extracted image G33 such that the extracted image G33 is disposed with the central part of the second area as the center.

The magnification of the partial image G21 at the time of generation of the extracted image G23 and the magnification of the partial image G31 at the time of generation of the extracted image G33 are determined to such values that the extracted image G23 fits in the first area and the extracted image G33 fits in the second area, for example, in consideration of the resolution of the second display 210, the size of the first area, the size of the second area, and the like.

The size of the first area and the size of the second area may be determined according to the size of the designated area on the first display 110 by the touch operation. For example, when the first designated area when the partial image G21 is designated by the touch operation is wider than the second designated area when the partial image G31 is designated by the touch operation, on the first display 110, the image display area of the second display 210 is divided into two such that the first area in which the extracted image G23 corresponding to the partial image G21 is displayed is wider than the second area in which the extracted image G33 corresponding to the partial image G31 is displayed, on the second display 210. When a difference between the size of the first designated area and the size of the second designated area is within a predetermined range, the image display area of the second display 210 is divided into two such that the size of the first area and the size of the second area are the same.

In step S52, second predetermined information is transmitted from the first display device 100 to the second display device 200. The second predetermined information includes information indicating a second display request instruction, information indicating the partial image position of the partial image G21 specified in step S30, information indicating the partial image position of the partial image G31, information indicating the extracted image position of the extracted image G23 specified in step S43, and information indicating the extracted image position of the extracted image G33. The second display request instruction is a control command instructing the second display device 200 to display each of the extracted image G23 and the extracted image G33 at the extracted image position specified in step S43.

Then, the second display device 200 receives the second predetermined information, and performs the processes illustrated in step S60 to step S110 of FIG. 4 for each of the extracted image G23 and the extracted image G33. As a result, as illustrated FIG. 10, the extracted image G23 is displayed in the first area (on the upper side) and the extracted image G33 is displayed in the second area (on the lower side), on the second display 210.

As illustrated in FIG. 11 and FIG. 12, in a case where the partial image G41 and the partial image G51 arranged on the left and right are determined by the two touch operations on the first display 110, No is determined in step S41, and the second specification process illustrated in step S43 is performed. In this case, in the second specification process, the image display area of the second display 210 is divided into a third area located on one side (on the left side) in the X-axis direction and a fourth area located on the other side (on the right side). Then, the extracted image position of the extracted image G43 and the extracted image position of the extracted image G53 are specified such that the extracted image G53 is disposed in the third area, and the extracted image G43 is displayed in the fourth area. As a result, as illustrated in FIG. 11, the extracted image G53 is displayed in the third area (left side), and the extracted image G43 is displayed in the fourth area (right side), on the second display 210.

In a case where the touch operation is performed on the first display 110 N times, N extracted images may be displayed so as to be arranged along the Y-axis direction or the X-axis direction on the second display 210. N is an integer greater than or equal to 3.

The present invention can be used in the fields of a display device, a display system, and a display method.

What is claimed is:

1. A display system comprising:
a first display device;
a second display device communicably connected to the first display device, wherein
the first display device includes:
a first display that displays an image; and
an operator that accepts a touch operation to the first display,
the second display device includes a second display that displays an image,
when one part of a display image displayed on the first display is designated by the touch operation, the second display displays an extracted image, and
the extracted image is an image obtained by extracting, from the display image, a partial image including a portion designated by the touch operation in the display image.

2. The display system according to claim 1, wherein
a frame part of the partial image is formed in a rectangular shape.

3. The display system according to claim 1, wherein
the extracted image is generated by enlarging the partial image, and
size of the extracted image is determined on the basis of size of the partial image and resolution of the second display.

4. The display system according to claim 1, wherein
the first display device further includes:
a specifier that specifies a partial image position that is an area where the partial image is located on the display image, and an extracted image position that is an area where the extracted image is located on the second display;
a communicator that transmits partial image position information indicating the partial image position and extracted image position information indicating the extracted image position, and
the second display device further includes:
a receiver that receives the partial image position information and the extracted image position information transmitted from the communicator;
a creator that creates the extracted image on the basis of the partial image position information; and
a controller that displays the extracted image on the second display such that the extracted image is displayed at the extracted image position.

5. The display system according to claim 1, wherein
the first, display device further includes:
a specifier that specifies a partial image position that is a location where the partial image is located on the display image and an extracted image position that is a location where the extracted image is located on the second display;
a creator that creates the extracted image on the basis of the partial image position specified by the specifier; and
a communicator that transmits information indicating the extracted image and information indicating the extracted image position, and
the second display device further includes:
a receiver that receives information indicating the extracted image and information indicating the extracted image position transmitted from the communicator; and
a controller that displays the extracted image on the second display such that the extracted image is displayed at the extracted image position.

6. The display system according to claim 1, wherein
the partial image includes:
a first partial image; and
a second partial image which is a portion different from the first partial image of the display image displayed on the first display, and
the extracted image includes:
a first extracted image which is an image obtained by extracting the first partial image from the display image, and
a second extracted image which is an image obtained by extracting the second partial image from the display image.

7. The display system according to claim 6, wherein
in a case where a position of the first partial image and a position of the second partial image are different at a position in a first direction on the first display, the second display displays the first extracted image and the second extracted image arranged side by side along the first direction.

8. The display system according to claim 6, wherein
in a case where a position of the first partial image and a position of the second partial image are the same at a position in a first direction on the first display, the second display displays the first extracted image and the second extracted image arranged side by side along a second direction perpendicular to the first direction.

9. A display device communicably connected to a display device including a first display, the display device comprising a second display that displays an image, wherein
when one part of the display image displayed on the first display is designated by a touch operation to the first display, the second display displays an extracted image, and
the extracted image is an image obtained by extracting, from the display image, a partial image including a portion designated by the touch operation in the display image.

10. A display method using a first display device and a second display device communicatively connected to the first display device, the display method comprising:
displaying a display image on a first display included in the first display device;
designating one part of the display image by a touch operation to the first display; and
displaying an extracted image on a second display included in the second display device, wherein
the extracted image is an image obtained by extracting, from the display image, a partial image including a portion designated by the touch operation in the display image.
